(19) United States
(12) Patent Application Publication
(10) Pub. No.: US 2025/0376196 A1
(43) Pub. Date: Dec. 11, 2025

(54) Method and Device for Ascertaining the Geometry of a Wheel, and Rail Vehicle

(71) Applicant: Siemens Mobility Austria GmbH, Wien (AT)

(72) Inventors: Bernhard Lukas GIRSTMAIR, Graz (AT); Gerald GRABNER, Graz (AT); Thomas MODER, Graz (AT); Thomas PUCHINGER-MENDLIK, Graz (AT); Gerald SCHAFFLER, Graz (AT); Christiane SCHWARZL, Wien (AT); Johannes SIMON, Graz (AT)

(21) Appl. No.: 18/878,238

(22) PCT Filed: Jun. 21, 2023
(86) PCT No.: PCT/EP2023/066829

§ 371 Date: Dec. 23, 2024

(30) Foreign Application Priority Data
Jun. 28, 2022 (AT) A50471/2022

(51) Int. Cl. B61K 9/12; G01M 17/10

(52) U.S. Cl. CPC B61K 9/12; G01M 17/10

(57) ABSTRACT

A method for ascertaining a geometry of a wheel for vehicles, in particular rail vehicles, wherein at least one first sensor is used to ascertain vertical accelerations of at least one first wheel, and travel speeds are processed and wherein amplitude spectra are formed based vertical acceleration signals that characterize the oscillatory behavior of the at least one first wheel, wherein an amplitude sum spectrum is formed from the amplitude spectra, at least one wheel harmonic is determined from at least one frequency of the amplitude sum spectrum that is assigned to the amplitude maximum of the amplitude sum spectrum, and the wheel geometry is ascertained from a standard driving speed, which defines a characteristic vehicle operating behavior, and from the at least one wheel harmonic such that a dedicated rotational speed sensor can be omitted.

### CROSS-REFERENCE TO RELATED APPLICATIONS

This is a U.S. national stage of application No. PCT/EP2023/066829 filed 21 Jun. 2023. Priority is claimed on Austrian Application No. A50471/2022 filed 28 Jun. 2022, the content of which is incorporated herein by reference in its entirety.

### BACKGROUND OF THE INVENTION

### 1. Field of the Invention

The invention relates to a method for ascertaining the geometry of a wheel for vehicles, in particular rail vehicles, where vertical accelerations of at least one first wheel are ascertained using at least one first sensor, where travel speeds are processed, and where amplitude spectra are formed based on vertical acceleration signals that characterize the oscillating behavior of the at least one first wheel.

### 2. Description of the Related Art

In the case of vehicles, there is often a need for precise knowledge of wheel geometry. For example, a wheel radius, a wheel diameter or a wheel circumference is required to determine wheel or wheel set speeds, for certain monitoring and diagnostic functions relating to wheels or wheel sets, or to determine speed via odometry, etc.

For example, EP 1 197 415 A2 discloses a method for detecting bearing damage. Here, a defined number of outer ring rollover harmonics is determined from acceleration signals, which are detected in the region of an axle bearing, and a characteristic value is determined therefrom, which indicates a bearing state.

Furthermore, EP 1 197 417 A1 discloses a method for wheel damage detection for rail vehicles. In this method, a defined number of wheel out-of-roundness harmonics is determined from acceleration signals, which are detected in the region of an axle bearing, and a characteristic value is determined therefrom, which indicates a wheel state.

In addition, WO 2018/059937 A1 shows a wheel arrangement for a rail vehicle with a speed sensor.

### SUMMARY OF THE INVENTION

It is an object of the invention to provide a vibration-based method for wheel geometry detection.

This and other objects and advantages are achieved in accordance with the invention by a method in which an amplitude sum spectrum is formed from the amplitude spectra, where at least one wheel harmonic is determined from at least one frequency of the amplitude sum spectrum that is assigned to the amplitude maximum of the amplitude sum spectrum, and where the wheel geometry is determined from a standard travel speed, which defines a characteristic vehicle operating behavior, and from the at least one wheel harmonic. This measure achieves a precise and at the same time simple method for wheel geometry determination in terms of material costs that, for example, can also be implemented in vehicles that do not have rotational speed sensors. With such implementations, there is no need for costly retrofitting of rotational speed sensors and associated cabling. However, it is also possible for the method in accordance with the invention to be used in redundancy to a wheel geometry determination based on measurements of a rotational speed sensor and thus achieve a validation of determination results.

In addition, many vehicles have acceleration sensors in the area of their wheels that measure vertical accelerations. For example, acceleration sensors for detecting vertical accelerations are often arranged on axle box bearing housings of the bogies for axle box bearing diagnostics in rail vehicles. Such equipment can be use by the method in accordance with the invention.

In the method in accordance with the invention, the wheel harmonic, for example, can be identified as a frequency of the amplitude sum spectrum, which is assigned to an amplitude maximum of the amplitude sum spectrum. However, the wheel harmonic can, for example, also be selected from a plurality of frequencies that are assigned to amplitude maxima of different search intervals within the amplitude sum spectrum. The standard travel speed can be, for example, an average speed over a defined period of time or also a defined constant, etc. The travel speeds can, for example, be measured but also determined etc. (for example, by deriving position data over time from a positioning apparatus).

It is advantageous, for example, if a wheel radius is determined as the wheel geometry via a radius formation rule

$$r = \frac{{v}_{n}}{2 π \cdot {f}_{h}}$$

or a wheel diameter is determined via a diameter formation rule

$$R = \frac{{v}_{n}}{π \cdot {f}_{h}} .$$

Knowledge of the wheel radius or the wheel diameter is advantageous for various applications. For example, the determined wheel radius or wheel diameter can be used in an odometrical method for determining the travel speed by means of rotational speed sensors or in a wheel speed determination process.

In equivalence to the wheel radius or the wheel diameter, for example, a wheel circumference can also be determined.

In a preferred embodiment, the at least one wheel harmonic is determined by excluding interference frequencies that are caused by processes other than a rotation of the at least one first wheel. In this way, the wheel geometry is determined with increased accuracy as the interference frequencies are filtered out. This measure makes it possible to form a quality measure which, for example, increases with the number of frequencies used in the wheel geometry determination, i.e., frequencies that are not filtered out. The greater the quality measure, for example, the greater the accuracy or plausibility of a determined wheel geometry value.

Parameterization and thus an increase in efficiency of the wheel geometry determination are made possible if the at least one wheel harmonic determines selected frequencies from a search area consisting of the standard travel speed, a defined maximum permissible wheel radius, a defined minimum permissible wheel radius and an order factor with k=1 . . . K from first intervals

$$[ \frac{k \cdot {v}_{n}}{2 π \cdot {r}_{max}} , \frac{k \cdot {v}_{n}}{2 π \cdot {r}_{min}} ]$$

or of the standard travel speed, a defined maximum permissible wheel diameter, a defined minimum permissible wheel diameter and an order factor with k=. . . K from second intervals

$$[ \frac{k \cdot {v}_{n}}{π \cdot {R}_{max}} , \frac{k \cdot {v}_{n}}{π \cdot {R}_{min}} ] .$$

Results of wheel geometry determination that are robust against statistical outliers are achieved if the at least one wheel harmonic is determined as the median of the frequencies selected from the search area, which are assigned to amplitude maxima of the amplitude sum spectrum within the first intervals or the second intervals.

Speed determination without the use of rotational speed sensors is made possible if a wheel speed is determined from a value of the travel speeds and the wheel radius via a first speed formation rule

$$n = \frac{v}{2 π \cdot r}$$

or from a value of the travel speeds and the wheel diameter via a second speed formation rule

$$n = \frac{v}{π \cdot R} .$$

However, it can also be helpful for speed determination if at least one core wheel harmonic is determined from frequencies within a core search area that is centered around first search values

$$\frac{k \cdot v}{2 π \cdot r} ,$$

which are formed from a value of the travel speeds, the wheel radius and an order factor with k=1 . . . K or around second search values

$$\frac{k \cdot v}{π \cdot R} ,$$

which are formed from a value of the travel speeds, the wheel diameter and an order factor with k=1 . . . K, a wheel speed being determined from the at least one core wheel harmonic and from at least one value for the order factor, for which a frequency selected from the core search area as the at least one core wheel harmonic is assigned to an amplitude maximum of the amplitude sum spectrum, via a third speed formation rule

$$n = \frac{{f}_{h 1}}{k}$$

or as statistical value from quotients that are formed by dividing a plurality of values for the core wheel harmonic by the values for the order factor respectively assigned to the values for the core wheel harmonic.

This measure achieves sufficiently accurate or plausible results for the wheel speed even with unreliable or inaccurate information with regard to the travel speeds. The value of the travel speeds is only used to determine the core wheel harmonic, the core wheel harmonic or a plurality of core wheel harmonics being sought in the core search area that, for example, is smaller than the search area for the wheel harmonic or a plurality of wheel harmonics. The wheel speed is determined from the core wheel harmonic or the plurality of core wheel harmonics, for which the value of the travel speeds is not directly required.

A high degree of accuracy of the determination results with regard to the wheel speed is ensured if the wheel speed is determined when the at least one wheel harmonic or the at least one core wheel harmonic is determined from a number of frequencies which is equal to or greater than a frequency number threshold value. This, for example, avoids the wheel harmonic or the core wheel harmonic being determined from a frequency spectrum which, for example, has a high number of interference frequencies to be filtered out.

Risks with respect to unreliable wheel geometry determination results are reduced if the amplitude spectra and/or the amplitude sum spectrum are formed and/or updated when the travel speeds are equal to or greater than a travel speed threshold and when travel accelerations are equal to or less than a travel acceleration threshold.

The travel accelerations can be mathematically positive, but also mathematically negative accelerations (i.e., decelerations). This can be taken into account via a sign of the travel acceleration threshold or via an absolute value formation for the travel accelerations. Equivalent to the travel accelerations and the travel acceleration threshold, driving or braking forces can also be compared with a driving or braking force threshold value.

Efficient utilization of available computer capacity is made possible when the amplitude spectra are formed in a first time interval and the sum amplitude spectrum is updated in a second time interval, where the second time interval is greater than the first time interval. Here, it is also helpful if partial sum amplitude spectra are formed from the amplitude spectra, which are temporarily stored in a third time interval that is greater than the first time interval and less than the second time interval, where the sum amplitude spectrum is formed from the partial sum amplitude spectra.

The objects and advantages associated with the method in accordance with the disclosed embodiments of the invention are also achieved by an apparatus comprising at least one first sensor, at least one computing facility and at least one facility for positioning, for determining the travel speed or for detecting the travel speed, if the at least one computing facility for determining the geometry of at least one first wheel is connected in a signal-transmitting manner to the at least first sensor for detecting vertical accelerations and to the at least one facility for positioning, for determining the travel speed or for detecting the travel speed.

In particular, it is favorable if a rail vehicle is equipped with at least one apparatus in accordance with. the invention.

In the case of rail vehicles, there is often a need for simple but precise wheel geometry determination (for example, in connection with diagnostic and/or monitoring facilities, with which, for example, wheel damage can be detected, etc.).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail hereinafter with reference to exemplary embodiments, in which:

FIG. 1: is a flow chart of an exemplary embodiment of the method in accordance with the invention, with which wheel geometry parameters and wheel speeds are determined; and

FIG. 2: is a schematic side view of a section of an exemplary embodiment of a rail vehicle in accordance with the invention with an exemplary embodiment of an apparatus in accordance with the invention for implementing a method in accordance with the invention for wheel geometry determination.

### DETAILED DESCRIPTION OF THE EXEMPLARY EMBODIMENTS

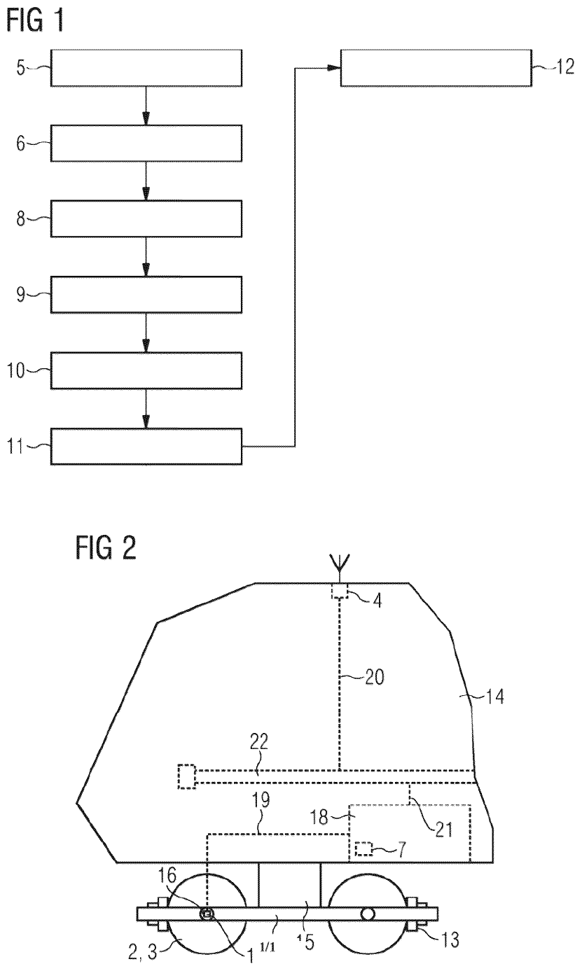

FIG. 1 shows a flow chart of an exemplary embodiment of a method in accordance with the invention, with which wheel geometry parameters and wheel speeds are determined. The method of FIG. 1 is provided for a rail vehicle, as shown by way of example in FIG. 2.

Vertical accelerations of a first wheel 2 of a wheel set 3, as shown by way of example in FIG. 2, are determined via a first sensor 1, as shown by way of example in FIG. 2. From a satellite-based positioning facility 4 of the rail vehicle, also shown by way of example in FIG. 2, position information of the rail vehicle is received, which is transformed by temporal deviation into travel speeds v to be processed in connection with the method according to the invention.

Based on vertical acceleration signals of the first sensor 1, which characterize an oscillating behavior of the first wheel 2, amplitude spectra are formed in a first time interval of 1 s, which are standardized to a standard travel speed vₙ, which is formed as an average value, i.e., as a statistical value from the travel speeds v recorded within one day. (Amplitude spectrum formation 5). In accordance with the invention, it is also possible for a different value (for example, a constant that characterizes a typical or particularly frequently occurring operating speed) to be used for the standard travel speed vₙ. In any event, the standard travel speed vₙ describes a characteristic operating behavior of a vehicle.

The amplitude spectra are accumulated, whereby partial sum amplitude spectra are formed (accumulation 6) and temporarily stored in a database 7 of the rail vehicle shown in FIG. 2 (temporary storage 8). The partial sum amplitude spectra are in turn combined in a second time interval of 1 d to form a sum amplitude spectrum (aggregation 9). Intermediate storage occurs in a third time interval of 1 h. The second time interval is therefore greater than the first time interval, the third time interval greater than the first time interval and less than the second time interval.

The amplitude spectrum formation 5, the accumulation 6, the intermediate storage 8, the aggregation 9 and all further steps of the method in accordance with the invention are performed under the condition that the travel speeds v are equal to or greater than a defined travel speed threshold and if travel accelerations are equal to or less than a defined travel acceleration threshold.

The travel accelerations can be mathematically positive, but also mathematically negative accelerations (i.e., decelerations). This is taken into account by a sign of the travel acceleration threshold or by an absolute value formation in the travel accelerations. In the exemplary embodiment of the method in accordance with the invention as illustrated in FIG. 1, a value of 5 km/h is set as the travel speed threshold, and a value of 0.01 m/s² is set as the travel acceleration threshold. In accordance with the invention, however, it is also possible to select other values.

A wheel harmonic fₕ is determined from frequencies of the amplitude sum spectrum, which are assigned to amplitude maxima of the amplitude sum spectrum (harmonic determination 10). Harmonics are spectral lines whose frequencies have an integer ratio to each other. This occurs in particular with Fourier transformations of periodic, non-sinusoidal signals. A fundamental harmonic is, for example, the harmonic with the lowest frequency, which corresponds to a reciprocal value of a period duration of such a signal.

In harmonic determination 10, the wheel harmonic fₕ is determined from selected frequencies. The frequencies are selected from a search area that consists of the standard travel speed vₙ, a defined maximum permissible wheel radius rₘₐₓ, a defined minimum permissible wheel radius rₘᵢₙ and an order factor k with k=1 . . . K (order maximum K with K=12, where in accordance with the invention other values can also be used for the order maximum K) from first intervals

$$[ \frac{k \cdot {v}_{n}}{2 π \cdot {r}_{max}} , \frac{k \cdot {v}_{n}}{2 π \cdot {r}_{min}} ] .$$

The maximum permissible wheel radius rₘₐₓ and the minimum permissible wheel radius rₘᵢₙ are operating limits. In accordance with the invention, it is also conceivable that the search area is formed from second intervals

$$[ \frac{k \cdot {v}_{n}}{π \cdot {R}_{max}} , \frac{k \cdot {v}_{n}}{π \cdot {R}_{min}} ] ,$$

in which instead of the maximum permissible wheel radius rₘₐₓ and the minimum permissible wheel radius rₘᵢₙ, a defined maximum permissible wheel diameter Rₘₐₓ and a defined minimum permissible wheel diameter Rₘᵢₙ are used.

The selected frequencies are assigned to amplitude maxima of the amplitude sum spectrum within the first interval (or the second interval if the search area is formed of these). In other words, those frequencies are selected from frequency-amplitude curves for which the frequency-amplitude curves have amplitude maxima.

The selected frequencies are standardized to the order factor k assigned to the respective first interval or second interval from which a frequency is selected. For example, a frequency from the first interval with an order factor of k=2 is divided by k=2 for standardization.

Interference frequencies outside a defined frequency band, which are caused by processes other than a rotation of the first wheel 2 (e.g., by recurring, dynamic interference from a contact between the first wheel 2 and a rail), are then filtered out from the selected and standardized frequencies, whereby the wheel harmonic fₕ is determined by excluding these interference frequencies. The greater the number of selected and unfiltered frequencies, the greater the value of a quality measure for the wheel geometry determination. The greater the quality measure, the more accurate and reliable the wheel geometry determination.

The wheel harmonic fₕ is then determined as the median of the frequencies selected, standardized and filtered from the search area. This completes the harmonic determination 10.

A wheel geometry is then determined from the standard travel speed vₙ and the wheel harmonic fₕ (geometry determination 11). Harmonic determination 10 and geometry determination 11 are performed once a day.

As wheel geometry, a wheel radius r is determined via a radius formation rule

$$r = \frac{{v}_{n}}{2 π \cdot {f}_{h}} .$$

In accordance with the invention, however, it is also conceivable that a wheel diameter R is determined as wheel geometry, for example, via a diameter formation rule

$$R = \frac{{v}_{n}}{π \cdot {f}_{h}} .$$

In accordance with the invention, it is also conceivable that vertical accelerations of a second wheel of the wheel set 3 are determined via a second sensor and thus a wheel geometry determination is also performed for the second wheel in accordance with the above-described methodology. The wheel radius r or the wheel diameter R can be determined, for example, as a mean radius or as a mean diameter with respect to the first wheel 2 and the second wheel.

Based on the determined wheel radius r or the determined wheel diameter R, a wheel speed n is then determined (speed determination 12), provided that the wheel harmonic fₕ is determined from a number of frequencies that is equal to or greater than a frequency number threshold value. In order for the wheel speed n to be determined, the above-mentioned quality measure must therefore be equal to or greater than the frequency number threshold value. The frequency number threshold value is defined as 10 for the exemplary embodiment of a method in accordance with the invention as illustrated in FIG. 1. In accordance with the invention, however, it is also possible to set other values as the frequency number threshold value.

In speed determination 12, the wheel speed n is determined from a current value of the travel speeds v and the wheel radius r via a first speed formation rule

$$n = \frac{v}{2 π \cdot r} .$$

In accordance with the invention, however, it is also possible to determine the wheel speed n from a value of the travel speeds v and the wheel diameter R via a second speed formation rule

$$n = \frac{v}{π \cdot R} .$$

Furthermore, it is conceivable, in particular in the case of unreliable information about the travel speeds v, that as an alternative speed determination 12 a core wheel harmonic fₕ₁ is determined via a third speed formation rule

$$n = \frac{{f}_{h 1}}{k}$$

from frequencies within a core search area, which is centered around first search values

$$\frac{k \cdot v}{2 π \cdot r} ,$$

which are formed from a value of the travel speeds v, the wheel radius r and an order factor k with k=1 . . . K or is centered around second search values

$$\frac{k \cdot v}{π \cdot R} ,$$

which are formed from a value of the travel speeds v, the wheel diameter R and an order factor k with k=1 . . . K, the wheel speed n being determined from the core wheel harmonic fₕ₁ and from the value for the order factor k, for which a frequency selected from the core search area as the core wheel harmonic fₕ₁ is assigned to an amplitude maximum of the amplitude sum spectrum. Centering around the first search values or the second search values occurs via interval formation. For example, third intervals are formed around the first search values by replacing the wheel radius r in the first search values for a lower limit of the third intervals with a lower limit value which lies between the values for the wheel radius r and the maximum permissible wheel radius rₘₐₓ and replacing the wheel radius r for an upper limit of the third intervals with an upper limit value which lies between the values for the wheel radius r and the minimum permissible wheel radius rₘᵢₙ. The core search area is also narrower than the above-mentioned search area for the wheel harmonic fₕ.

For the second search values, the same procedure can be followed for interval formation based on the wheel diameter R, the maximum permissible wheel diameter Rₘₐₓ and the minimum permissible wheel diameter Rₘᵢₙ, where fourth intervals are formed around the second search values by replacing the wheel diameter R with a lower limit value in the second search values for a lower limit of the fourth intervals, which lies between the values for the wheel diameter R and the maximum permissible wheel diameter Rₘₐₓ and, for an upper limit of the fourth intervals, replacing the wheel diameter R with an upper limit value that lies between the values for the wheel diameter R and the minimum permissible wheel diameter Rₘᵢₙ.

If a plurality of values for the core wheel harmonic fₕ₁ is selected from the core search area (for example, a value for the core wheel harmonic fₕ₁ is selected for each value of the order factor k with an order maximum K of K>1), then the wheel speed n is determined as a statistical value (for example, as a median) from quotients that are formed by dividing the plurality of values for the core wheel harmonic fₕ₁ by the values for the order factor k assigned in each case to the values for the core wheel harmonic fₕ₁. A frequency number threshold value can also be assumed for the alternative speed determination 12 by means of the core wheel harmonic fₕ₁.

If the wheel radius r or the wheel diameter R is determined and this can be used for speed determination 12, the amplitude spectrum formation 5, the accumulation 6 and the intermediate storage 8 can be implemented at the same time as the speed determination 12 (for example, by performing the amplitude spectrum formation 5, the accumulation 6 and the intermediate storage 8 using a first processor or a first processor core and the speed determination 12 using a second processor or a second processor core). Speed determination 12 is performed every second.

FIG. 2 shows a side view of a section of an exemplary embodiment of a rail vehicle in accordance with the invention with an exemplary embodiment of an apparatus in accordance with the invention for implementing a method in accordance with the invention for wheel geometry determination, as shown by way of example in connection with FIG. 1.

The rail vehicle has a bogie 13 and a railcar body 14, where the railcar body 14 is supported on the bogie 13 via a secondary air spring assembly 15. A first sensor 1 is connected to a cover of a first axle box bearing housing 16 of a first wheel set bearing. The first sensor 1 is formed as a piezo acceleration sensor.

A second sensor formed as a piezo acceleration sensor, which is not shown in FIG. 2, is connected to a second axle box bearing housing, also not shown in FIG. 2, of a second wheel set bearing of the bogie 13. Via the first wheel set bearing and the first axle box bearing housing 16 and the second wheel set bearing and the second axle box bearing housing, a first wheel set 3 comprising a first wheel 2 and a second wheel (not shown in FIG. 2) is resiliently coupled to a chassis frame 17.

Vertical accelerations of the first wheel 2 are detected via the first sensor 1, and vertical accelerations of the second wheel via the second sensor.

A computing facility 18 with an implemented database 7 is arranged in the railcar body 14, via which signals of the first sensor 1 and the second sensor are processed. A satellite-based positioning facility 4 with an antenna is connected to a roof of the railcar body 14. The positioning facility 4 is configured as a Global Positioning System (GPS). The positioning facility 4 is used to determine travel speeds v of the rail vehicle. In order to determine the travel speeds v, however, it is also conceivable in accordance with the invention to arrange a facility for recording or measuring the travel speeds v in or on the railcar body 14 (for example, a facility for Doppler radar speed measurement, etc.).

Based on the signals relating to the vertical accelerations and the travel speeds v, those steps of the exemplary embodiment of a method in accordance with the invention described in connection with FIG. 1, i.e., an amplitude spectrum formation 5, an accumulation 6, an intermediate storage 8, an aggregation 9, a harmonic determination 10, a geometry determination 11 and a speed determination 12, are implemented in the computing facility 18.

The first sensor 1, the second sensor, the computing facility 18 and the positioning facility 4 are parts of the exemplary embodiment of an apparatus in accordance with the invention for implementing the method in accordance with the invention for wheel geometry determination, as described by way of example in connection with FIG. 1.

In order to determine a wheel radius r and a wheel speed n, which are also mentioned in connection with FIG. 1, the computing facility 18 is connected in a signal-transmitting manner to the first sensor 1 and the second sensor and to the positioning facility 4.

A first signal line 19 is provided between the first sensor 1 and the computing facility 18, and a second signal line 20 is provided between the positioning facility 4 and a vehicle bus 22, which runs in the railcar body 14. The vehicle bus 22 is connected to the computing facility 18 via a third signal line 21 for data transmission from the positioning facility 4 to the computing facility 18. The second sensor is connected to the computing facility 18 via a fourth signal line not shown in FIG. 2.

In accordance with the invention, it is also conceivable to provide radio connections between the computing facility 18, on the one hand, and the first sensor 1, the second sensor and the positioning facility 4, on the other hand.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A method for wheel geometry determination for vehicles, vertical accelerations of at least one first wheel being determined via at least one first sensor, travel speeds (v) being processed, and amplitude spectra being formed based on vertical acceleration signals which characterize an oscillating behavior of the at least one first wheel, the method comprising:
forming an amplitude sum spectrum from the amplitude spectra; and
determining at least one wheel harmonic (fₕ) from at least one frequency of the amplitude sum spectrum which is assigned to an amplitude maximum of the amplitude sum spectrum; and determining a wheel geometry from a standard travel speed (vₙ) which defines a characteristic vehicle operating behavior, and from the at least one wheel harmonic (fₕ).

17. The method as claimed in claim 16, wherein a wheel radius (r) is determined as the wheel geometry via a radius formation relationship
$$r = \frac{{v}_{n}}{2 π \cdot {f}_{h}}$$
or a wheel diameter (R) is determined via a diameter formation relationship
$$R = \frac{{v}_{n}}{π \cdot {f}_{h}} .$$

18. The method as claimed in claim 17, wherein the amplitude spectra are standardized to the standard travel speed (vₙ).

19. The method as claimed in claim 17, wherein the amplitude spectra are standardized to the standard travel speed (vₙ).

20. The method as claimed in claim 16, wherein the at least one wheel harmonic (fₕ) is determined excluding interference frequencies which are caused by processes other than a rotation of the at least one first wheel.

21. The method as claimed in claim 17, wherein the at least one wheel harmonic (fₕ) is determined excluding interference frequencies which are caused by processes other than a rotation of the at least one first wheel.

22. The method as claimed in claim 18, wherein the at least one wheel harmonic (fₕ) is determined excluding interference frequencies which are caused by processes other than a rotation of the at least one first wheel.

23. The method as claimed in claim 16, wherein the at least one wheel harmonic (fₕ) determines selected frequencies from a search area consisting of one of (i) the standard travel speed (vₙ), a defined maximum permissible wheel radius (rₘₐₓ), a defined minimum permissible wheel radius (rₘᵢₙ) and an order factor (k) with k=1 . . . K from first intervals
$$[ \frac{k \cdot {v}_{n}}{2 π \cdot {r}_{max}} , \frac{k \cdot {v}_{n}}{2 π \cdot {r}_{min}} ]$$
and (ii) the standard travel speed (vₙ), a defined maximum permissible wheel diameter (Rₘₐₓ), a defined minimum permissible wheel diameter (Rₘᵢₙ) and an order factor (k) with k=1 . . . K from second intervals
$$[ \frac{k \cdot {v}_{n}}{π \cdot {r}_{max}} , \frac{k \cdot {v}_{n}}{π \cdot {r}_{min}} ] ,$$

24. The method as claimed in claim 23, wherein the selected frequencies are standardized to the order factor (k).

25. The method as claimed in claim 23, wherein the at least one wheel harmonic (fₕ) is determined as a median of the frequencies selected from the search area, which are assigned to amplitude maxima of the amplitude sum spectrum within the first intervals or the second intervals.

26. The method as claimed in claim 17, further comprising:
determining a wheel speed (n) from one of (i) a value of the travel speeds (v) and the wheel radius (r) via a first speed formation relationship
$$n = \frac{v}{2 π \cdot r}$$
and (ii) a value of the travel speeds (v) and the wheel diameter (R) via a second speed formation relationship
$$n = \frac{v}{π \cdot R} .$$

27. The method as claimed in claim 17, wherein at least one core wheel harmonic (fₕ₁) is determined from frequencies within a core search area which is centered around one of (i) first search values
$$\frac{k \cdot v}{2 π \cdot r} ,$$
which are formed from a value of the travel speeds (v), the wheel radius (r) and an order factor (k) with k=1 . . . K and (ii) second search values
$$\frac{k \cdot v}{π \cdot R} ,$$
which are formed from a value of the travel speeds (v), the wheel diameter (R) and an order factor (k) with k=1 . . . K; and
wherein a wheel speed (n) is determined from the at least one core wheel harmonic (fₕ₁) and from at least one value for the order factor (k), for which a frequency selected from the core search area as one of (i) the at least one core wheel harmonic (fₕ₁) is assigned to an amplitude maximum of the amplitude sum spectrum, via a third speed formation rule
$$n = \frac{{f}_{h 1}}{k}$$
and (ii) a statistical value from quotients which are formed by dividing a plurality of values for the core wheel harmonic (fₕ₁) by the values for the order factor (k) respectively assigned to the values for the core wheel harmonic (fₕ₁).

28. The method as claimed in claim 26, wherein the wheel speed (n) is determined when the at least one wheel harmonic (fₕ) or the at least one core wheel harmonic (fₕ₁) is determined from a number of frequencies which is equal to or greater than a frequency number threshold value.

29. The method as claimed in claim 16, wherein at least one of the amplitude spectra and the amplitude sum spectrum are at least one of formed and updated when the travel speeds (v) are equal to or greater than a travel speed threshold and when travel accelerations are equal to or less than a travel acceleration threshold.

30. The method as claimed in claim 16, wherein the amplitude spectra are formed in a first time interval and the sum amplitude spectrum is updated in a second time interval; and wherein the second time interval is greater than the first time interval.

31. The method as claimed in claim 30, wherein the partial sum the amplitude spectra are formed from the amplitude spectra, which are temporarily stored in a third time interval which is greater than the first time interval and less than the second time interval; and wherein the sum amplitude spectrum is formed from the partial sum amplitude spectra.

32. The method as claimed in claim 16, wherein the vehicles comprise rail vehicles.

33. An apparatus comprising:
at least one first sensor;
at least one computing facility; and
at least one facility for one of positioning, determining travel speed and detecting the travel speed;
wherein the at least one computing facility for geometry determination of at least one first wheel is connected in a signal-transmitting manner to the at least first sensor for detecting vertical accelerations and to the at least one facility for one of the positioning, determining the travel speed and detecting the travel speed.

34. A rail vehicle with at least one apparatus as claimed in claim 33.
